(19) United States
(12) Patent Application Publication
(10) Pub. No.: US 2026/0223776 A1
(43) Pub. Date: Aug. 6, 2026

(54) Global Swath Alignment

(71) Applicant: Autonomous Solutions, Inc., Mendon, UT (US)

(72) Inventor: Nate Bunderson, Mendon, UT (US)

(73) Assignee: Autonomous Solutions, Inc., Mendon, UT (US)

(21) Appl. No.: 19/462,939

(22) Filed: Jan. 28, 2026

Related U.S. Application Data
(60) Provisional application No. 63/751,974, filed on Jan. 31, 2025.

(51) Int. Cl. A01D 34/00; A01D 101/00; G05D 1/648; G05D 105/15; G05D 107/20

(52) U.S. Cl. CPC A01D 34/008; G05D 1/6484; A01D 2101/00; G05D 2105/15; G05D 2107/24

(57) ABSTRACT

An autonomous work vehicle may include a steering control system, a speed control system, and a sensor array. One or more processors may be communicatively coupled with the sensor array, the steering control system, and the speed control system. One or more computer-readable media may store instructions that cause the processors to identify a reference line within a map of two unconnected work areas. The processors may determine a swath angle and create a plurality of swaths based on the swath angle relative to the reference line. Alternating swaths may represent opposite directions. The plurality of swaths may overlap the two unconnected work areas within the map. The processors may trim the plurality of swaths based on geometric shape of the two unconnected work areas and create a path from the plurality of swaths.

### BACKGROUND

Autonomous mowing systems have gained prominence in various applications including golf course maintenance, sports field management, large property landscaping, and agricultural operations, where consistent, high-quality mowing results are desired while reducing labor requirements and operational costs. A significant challenge in autonomous mowing operations involves creating aesthetically pleasing and professionally coordinated mowing patterns across multiple discrete work areas such as golf course fairways, sports fields, or lawn sections. In present autonomous mowing solutions, direction of mowing creates different visible striping patterns or swaths. Achieving aligned and coordinated swath patterns across multiple separated work areas presents technical difficulties, as each work area may be planned and mowed independently, potentially resulting in misaligned swaths, inconsistent spacing, or visually uncoordinated appearances that detract from the overall aesthetic quality of the maintained areas.

### SUMMARY

In some embodiments, an autonomous work vehicle may include a steering control system for autonomously controlling a driving direction. The autonomous work vehicle may include a speed control system for autonomously controlling a speed. The autonomous work vehicle may include a sensor array comprising one or more sensors configured to measure operational variables. The autonomous work vehicle may include one or more processors communicatively coupled with the sensor array, the steering control system, and the speed control system. The autonomous work vehicle may include one or more computer-readable media having stored thereon instructions.

The two unconnected work areas may be non-contiguous. The two unconnected work areas may be adjacent. The autonomous work vehicle may operate along the path to create a swath pattern across the two unconnected work areas. The swath path may be optimized by modifying the swath angle. The swath path may be optimized by modifying a starting point of the path.

The instructions may cause the processors to identify a reference line within a map of two unconnected work areas. The processors may determine a swath angle. The processors may create a plurality of swaths based on the swath angle relative to the reference line. Alternating swaths may represent opposite directions. The plurality of swaths may overlap the two unconnected work areas within the map. The processors may trim the plurality of swaths based on geometric shape of the two unconnected work areas. The processors may create a path from the plurality of swaths.

Creating the path may comprise connecting adjacent swaths along the path. The path may proceed along a center of each swath within boundaries of the two unconnected work areas. When the autonomous work vehicle proceeds along the path, a pattern may be created in vegetation in each of the two unconnected work areas such that a swath line in one work area is aligned with a swath line of the other work area. The autonomous work vehicle may include a mower reel or blade. The unconnected work areas may comprise unconnected grass fairways.

In some embodiments, a method for creating a global swath pattern in two unconnected fairways for an autonomous mower may comprise identifying a reference line within a map of the two unconnected fairways. The method may comprise determining a swath angle. The method may comprise creating a plurality of swaths based on the swath angle relative to the reference line. The method may comprise trimming the plurality of swaths based on geometric shape of the two unconnected fairways. The method may comprise creating a path from the plurality of swaths.

### BRIEF DESCRIPTION OF THE FIGURES

FIG. 1 illustrates a block diagram of an example autonomous mower communication system of the present disclosure.

FIG. 2 is an isometric view of an autonomous mower.

FIG. 3A & FIG. 3B show different fairways.

FIG. 4A shows an example global swath pattern superimposed over the fairway shown in FIG. 3A.

FIG. 4B shows an example global swath pattern superimposed over the fairway shown in FIG. 3B.

FIG. 5A shows the swath pattern in the fairway of FIG. 3A.

FIG. 5B shows the swath pattern in the fairway of FIG. 3B.

FIG. 6 is a flowchart of a process for creating swath patterns in a fairway.

FIG. 7 is a flowchart of a process for optimizing swath paths

FIG. 8 is a block diagram of an example computational system (or controller).

### DETAILED DESCRIPTION

Systems and/or methods are disclosed for creating aligned swaths along different and/or separated areas operated by an autonomous work vehicle such as, for example, an autonomous mower.

A work area for an autonomous mower may include a first work area and a second work area that are separated by each other. The first work area and the second work area, for example, may be separated by a path or road or body of water or different material (e.g., not grass, or agricultural material) that is located between the first work area and the second work area. The first work area and the second work area may include the same type of work to be performed in each area such as, for example, mowing, plowing, harvesting, etc. The first work area and the second work area may require an autonomous vehicle to operate in a pattern that includes a plurality of swaths.

The first work area and the second work area, for example, may be part of a sports field, golf course, pasture, yard, agricultural field, etc. While an autonomous mower is described, any type of autonomous vehicle may be used such as, for example, an autonomous tractor, harvester, combine, etc.

A single swath, for example, may include a straight path followed by an autonomous mower across a portion of a work area followed by a corresponding straight path followed by the autonomous mower in the opposite direction. Multiple swaths may be lined up across the area in order for the autonomous mower to cover substantially all or all the work area with repeated swaths. Because of the autonomous mower's physical characteristics, every other swath may appear to have a different color or contrast or reflectivity or the like when viewed by an observer from a distance. The swaths taken together in a whole can be seen as pattern of swaths. A global swath pattern may be a plurality of swaths that repeat across two different work areas. When the work areas are mowed according to a global swath pattern, the swaths in the two areas will be aligned such that the swaths in each work area have the same angle and swath edges are substantially parallel and would form a straight line if connected.

Corresponding swaths, for example, may create a pattern of alternating parallel swaths within the work areas. A swath, for example, may be defined by an angle relative to an arbitrary reference line within or near the work area.

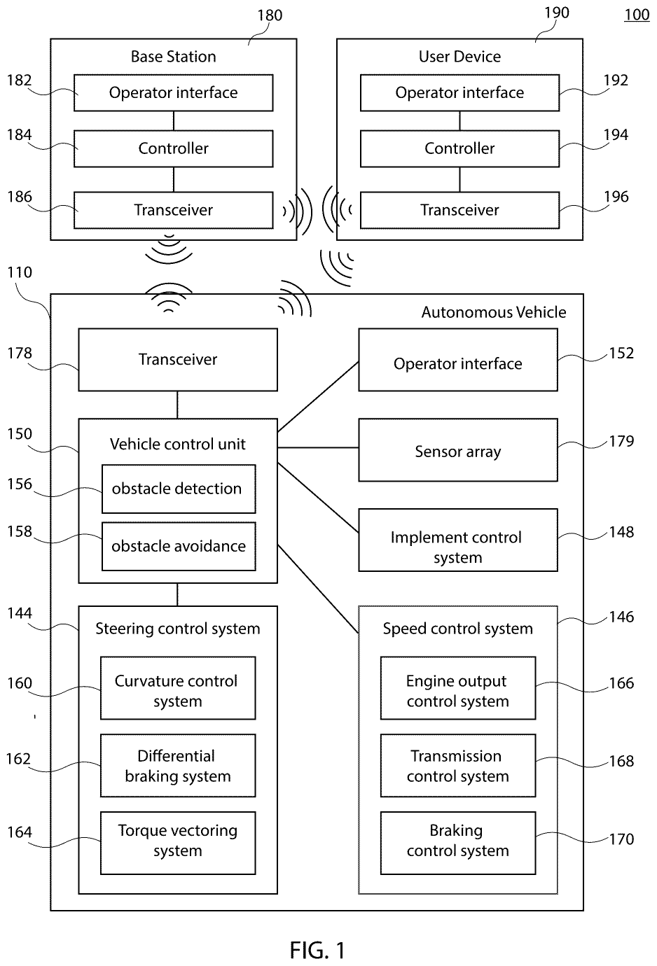

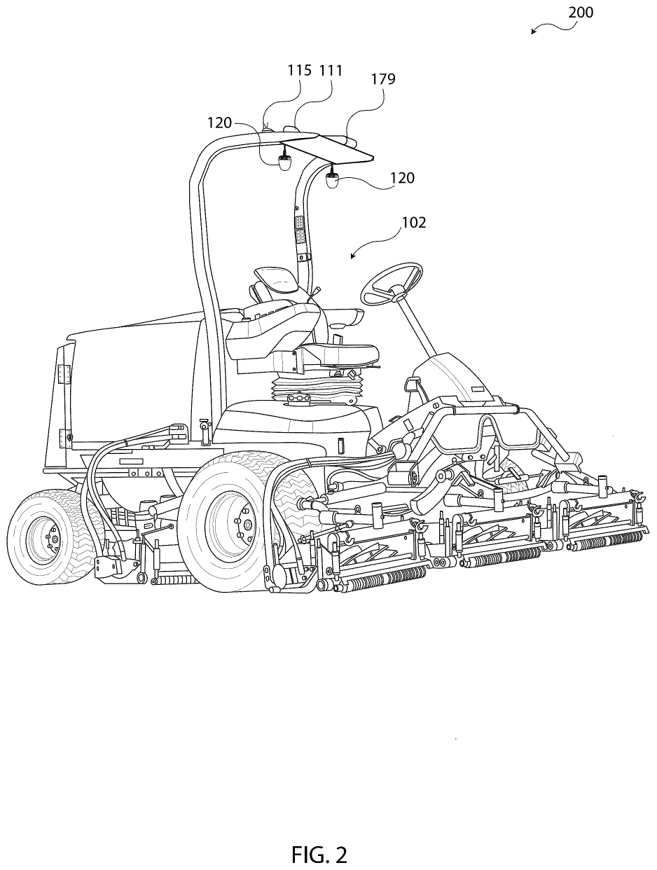

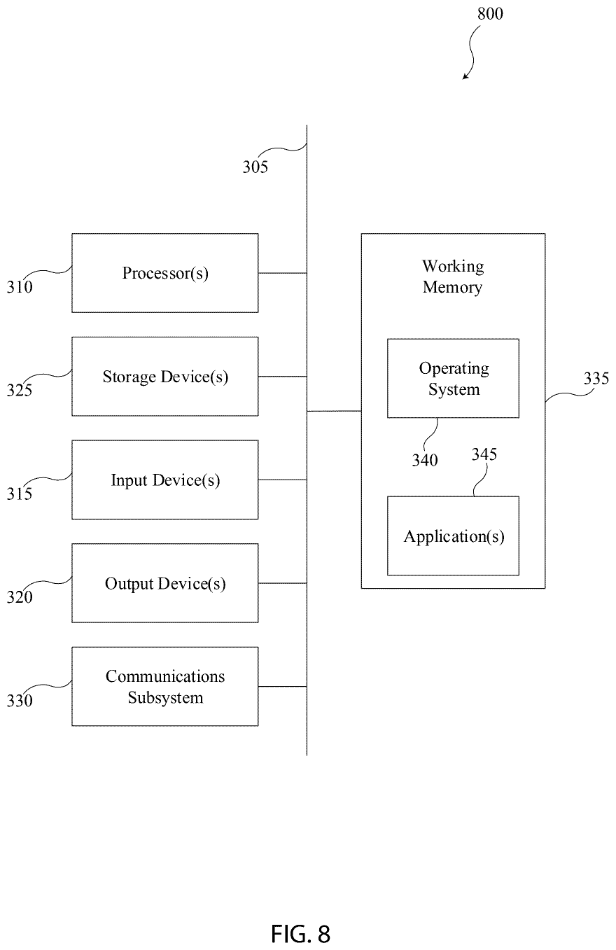

FIG. 1 is a block diagram of a communication and control system 100 for an autonomous mower that may be utilized in conjunction with the systems and methods of the disclosure. The communication and control system 100 may include a vehicle control unit 150 which may be mounted on an autonomous mower 110. The autonomous mower 110, for example, may include a mower, yard truck, loader, wheel loader, track loader, dump truck, digger, backhoe, forklift, etc. The communication and control system 100, for example, may include any or all components of computational system 800 shown in FIG. 8.

For example, the autonomous mower 110 may include a steering control system 144 that may control a direction of movement of the autonomous mower 110. The steering control system 144, for example, may include any or all components of computational system 800 shown in FIG. 8.

The autonomous mower 110, for example, may include a speed control system 146 that controls the speed, acceleration, and deceleration of the autonomous mower 110. The speed control system 146, for example, may control the speed of the autonomous mower 110 based on map data, control algorithms, obstacle detection, start and/or stop points, input from the base station 174, etc. The speed control system 146, for example, may include any or all components of computational system 800 shown in FIG. 8.

The autonomous mower 110, for example, may include an implement control system 148 that may control operation of an implement towed the autonomous mower 110 or integrated within the autonomous mower 110 or coupled to the autonomous mower 110. The implement control system 148 may, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, mower, etc. The implement control system 148, for example, may include any or all components of computational system 800 shown in FIG. 8.

The vehicle control unit 150 may be communicatively coupled with the steering control system 144, the speed control system 146, and the implement control system 148. The vehicle control unit 150, for example, may include any or all the components shown in FIG. 8. The vehicle control unit 150, for example, may be integrated into a single controller or may include a plurality of distinct components or controllers. The vehicle control unit 150 may also be coupled with one or more sensors from the sensor array 179 and receive sensor data from the sensor array 179.

The vehicle control unit 150, for example, may be used to control various aspects of the vehicle such as, for example, sending instructions to the steering control system 144, implement control system 148, speed control system 146, etc. The vehicle control unit 150, for example, may include a vehicle artificial intelligence (VAI) that may include one or more processors that execute one or more algorithms.

The vehicle control unit 150, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensory array 179 or from base station 174.

The vehicle control unit 150, for example, may be an electronic controller with electrical circuitry configured to process data from the various components of the autonomous mower 110. The vehicle control unit 150 may include any or all a processor, such as the processor 310, and a working memory 335. The vehicle control unit 150 may also include one or more storage devices and/or other suitable components of computational system 800. The processor 154 may be used to execute software, such as software for calculating drivable path plans. Moreover, the processor 154 may include multiple microprocessors, one or more “general-purpose” microprocessors, one or more special-purpose microprocessors, and/or one or more application specific integrated circuits (ASICS), or any combination thereof. For example, the processor 154 may include one or more reduced instruction set (RISC) processors. The vehicle control unit 150, for example, may include any or all the components shown in FIG. 8.

The vehicle control unit 150, for example, may include a volatile memory, such as random access memory (RAM), and/or a nonvolatile memory, such as ROM (e.g., working memory 335 and/or storage device 325). The memory may store a variety of information and may be used for various purposes. For example, the memory may store processor-executable instructions (e.g., firmware or software) for the vehicle control unit 150 to execute, such as instructions for calculating drivable path plan, and/or controlling the autonomous mower 110. The memory may include flash memory, one or more hard drives, or any other suitable optical, magnetic, or solid-state storage medium, or a combination thereof. The memory may store data such as field maps, maps of desired paths, vehicle characteristics, software or firmware instructions and/or any other suitable data.

The steering control system 144, for example, may include a curvature rate control system 160, a differential braking system 162, a steering mechanism, and a torque vectoring system 164 that may be used to steer the autonomous mower 110. The curvature rate control system 160, for example, may control a direction of an autonomous mower 110 by controlling a steering control system of the autonomous mower 110 with a curvature rate, such as an Ackerman style autonomous mower, 110 or articulating vehicle. The curvature rate control system 160, for example, may automatically rotate one or more wheels or tracks of the autonomous mower 110 via hydraulic or electric actuators to steer the autonomous mower 110. By way of example, the curvature rate control system 160 may rotate front wheels/tracks, rear wheels/tracks, and/or intermediate wheels/tracks of the autonomous mower 110 or articulate the frame of the vehicle, either individually or in groups. The differential braking system 162 may independently vary the braking force on each lateral side of the autonomous mower 110 to direct the autonomous mower 110. Similarly, the torque vectoring system 164 may differentially apply torque from the engine to the wheels and/or tracks on each lateral side of the autonomous mower 110. While the illustrated steering control system 144 includes the curvature rate control system 160, the differential braking system 162, and the torque vectoring system 164, the steering control system 144 may include one or more of these systems. Further examples may include a steering control system 144 having other and/or additional systems to facilitate turning the autonomous mower 110 such as an articulated steering control system, a differential drive system, and the like.

The speed control system 146, for example, may include an engine output control system 166, a transmission control system 168, and a braking control system 170. The engine output control system 166 may vary the output of the engine to control the speed of the autonomous mower 110. For example, the engine output control system 166 may vary a throttle setting of the engine, a fuel/air mixture of the engine, a timing of the engine, and/or other suitable engine parameters to control engine output. In addition, the transmission control system 168 may adjust gear selection within a transmission to control the speed of the autonomous mower 110. Furthermore, the braking control system 170 may adjust braking force to control the speed of the autonomous mower 110. While the illustrated speed control system 146 includes the engine output control system 166, the transmission control system 168, and the braking control system 170, the speed control system 146 may include one or two of these systems. The speed control system 146, for example, may also include other systems and/or additional systems that may be used to control the speed of the autonomous mower 110.

The implement control system 148, for example, may control various parameters of the implement towed by and/or integrated within the autonomous mower 110. For example, the implement control system 148 may instruct an implement controller via a communication link, such as a CAN bus, ISOBUS, Ethernet, wireless communications, and/or Broad R Reach type Automotive Ethernet, etc.

The implement control system 148, for example, may instruct an implement controller to adjust a penetration depth of at least one ground engaging tool of an agricultural implement, which may reduce the draft load on the autonomous mower 110.

The implement control system 148, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc.

The implement control system 148, as another example, may instruct the implement controller to adjust a shovel height, a shovel angle, a shovel position, etc.

The implement control system 148, as another example, may instruct the implement controller to adjust a shovel height, a shovel angle, a shovel position, etc.

The communication and control system 100, for example, may include a sensor array 179. The sensor array 179, for example, may facilitate determination of condition(s) of the autonomous mower 110 and/or the work area. For example, the sensor array 179 may include one or more sensors (e.g., infrared sensors, ultrasonic sensors, magnetic sensors, tachometer, radar sensors, Lidar sensors, terahertz sensors, sonar sensors, wheel encoders, cameras, etc.) that monitor a rotation rate of a respective wheel or track and/or a ground speed of the autonomous mower 110. The sensors may also monitor operating levels (e.g., temperature, fuel level, etc.) of the autonomous mower 110. Furthermore, the sensors may monitor conditions in and around the work area, such as temperature, weather, wind speed, compass, humidity, and other conditions. The sensors of the sensor array 179, for example, may detect physical objects in the work area, such as a parking stall, a material stall, accessories, other vehicles, obstacles, environmental features, or other object(s) that may in the area surrounding the autonomous mower 110.

The sensor array 179, for example, may include a velocity sensor which may include one or more of an inertial measurement unit, a compass, a GPS sensor, a wheel encoder, a tachometer, a camera, a radar, etc. The sensor array 179, for example, may also include a steering angle sensor. The velocity sensor, for example, may produce velocity data. Velocity data may include speed and/or bearing. Velocity data, for example, may also include steering angular rate.

The operator interface 152, for example, may be communicatively coupled to the vehicle control unit 150 and configured to present data from the autonomous mower 110 via a display. Display data may include data associated with operation of the autonomous mower 110, data associated with operation of an implement, a position of the autonomous mower 110, a speed of the autonomous mower 110, a desired path, a drivable path plan, a target position, a current position, etc. The operator interface 152 may enable an operator to control certain functions of the autonomous mower 110 such as starting and stopping the autonomous mower 110, inputting a desired path, etc. The operator interface 152, for example, may enable the operator to input parameters that cause the vehicle control unit 150 to adjust the drivable path plan. For example, the operator may provide an input requesting that the desired path be acquired as quickly as possible, that an off-path normal error be minimized, that a speed of the autonomous mower 110 remain within certain limits, that a lateral acceleration experienced by the autonomous mower 110 remain within certain limits, etc. In addition, the operator interface 152 (e.g., via the display, or via an audio system (not shown), etc.) may alert an operator if the desired path cannot be achieved, for example.

The vehicle control unit 150, for example, may include a base station 174 having a base station controller 176 located remotely from the autonomous mower 110. For example, the control functions of the vehicle control unit 150 may be distributed between the vehicle control unit 150 of the autonomous mower control unit 150 and the base station controller 176. The base station controller 176, for example, may perform a substantial portion of the control functions of the vehicle control unit 150. For example, a first transceiver 178 positioned on the autonomous mower 110 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 180 at the base station 174. The base station controller 176, for example, may calculate drivable path plans and/or output control signals to control the curvature rate control system 160, the speed control system 146, and/or the implement control system 148 to direct the autonomous mower 110 toward the desired path, for example. The base station controller 176 may include a processor and memory device having similar features and/or capabilities as the processor and the memory device discussed previously. Likewise, the base station 174 may include an operator interface 186 having a display 188, which may have similar features and/or capabilities as the operator interface 152 and the display discussed previously.

In some embodiments, whether or both the base station 174 and/or the autonomous mower 110 may be in communication with a user device 190. A user device my include a phone, tablet, laptop, or computer. The user device 190, for example, can include an application that allows the user to communicate commands to the autonomous mower 110 and/or receive information about the autonomous mower 110. Alternatively or additionally, the user device 190, for example, can include an application that allows the user to observe the autonomous mower 110 move through a map of the work area where the autonomous mower operates.

A user device may include a phone, tablet, laptop, or computer. The user device 190, for example, can include an application is executable by a controller 194 that allows the user to interact with the communication and control system 100 via an operator interface 192. The user device 190 may communicate commands to the autonomous work vehicle 110 and/or receive information about the autonomous work vehicle 110 via transceiver 196 and/or the user device 190 may communicate commands with the base station 180 and/or receive information from the base station 180 via transceiver 196. Alternatively, or additionally, the user device 190, for example, can include an application that allows the user to observe the autonomous work vehicle 110 move through a map of the work area where the autonomous work vehicle operates. Alternatively, or additionally, the user device 190, for example, can provide images from one or more sensors of the sensor array 179.

The user device 190, for example, may include an application that can receive any of the user inputs disclosed in this document. The user device 190, for example, may include an application that can display any of the information disclosed in this document.

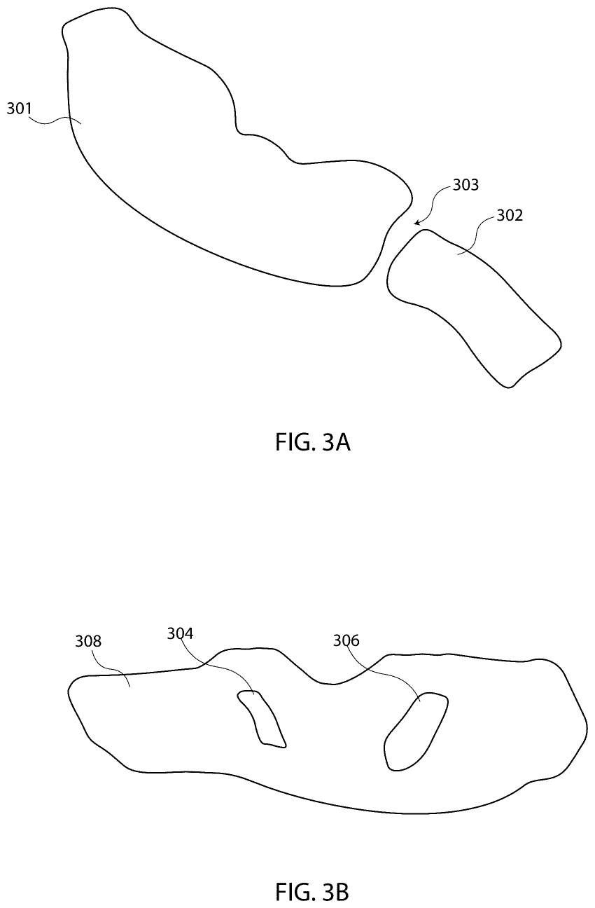

FIG. 3 is a sideview of an example autonomous mower 200. In this example, the autonomous mower 200 includes a disc mower. Any type of mower or blades may be used instead of the disc mower. The autonomous mower 200 may include an operator seat 102 or cab that may be used to drive the autonomous mower 200 manually. The autonomous mower 200 may include one or more controllers as described with reference to FIG. 8 below. The autonomous mower 200 may also include a brake system, an engine, a transmission, steering, etc.

In some embodiments, the autonomous mower 200, may include a sensor array 179 (or multiple sensor arrays) including sensors disposed at various locations on the autonomous mower 200 such as, for example, on the operator seat 102, on the frame, housing etc. The sensor array 179 may include one or more Lidar sensors 120. The Lidar sensors 120 may provide Lidar data comprising a point cloud including a plurality of points corresponding to objects and surfaces which reflect laser pulses from the Lidar sensors 120. In some examples, the sensor array 179 may also include other sensors, for example, infrared sensors, ultrasonic sensors, magnetic sensors, radar sensors, terahertz sensors, sonar sensors, a camera system including one or more cameras, etc.

In some embodiments, the autonomous mower 200 may include a spatial locating device (or GPS) 111. In some embodiments, the autonomous mower 200 may include a transceiver antenna 115.

FIG. 3A shows two work areas: a first work area 301 and a second work area 302. As shown, the first work area 301 is separated by the second work area 302. These work areas may be separated by an unworked area 303 that is not part of the work area and will not be mowed or processed by the autonomous mower. The unworked area 303, for example, may not include the vegetation of interest. The unworked area 303, for example, may not include grass or turf. The unworked area 303, for example, may be an area where the autonomous mowers mowing mechanism is not engaged.

FIG. 3B shows a work area 308 that has two islands: a first island 304 and a second island 306. Any number of islands may be included. The islands are areas within the work area 301 that are not mowed. These islands, for example, may not include the vegetation of interest. These islands, for example, may not include grass or turf. These islands, for example, may be an area where the autonomous mowers mowing mechanism is not engaged. These islands, for example, may be a sand trap within a golf course fairway. These islands, for example, may include rocks or boulders.

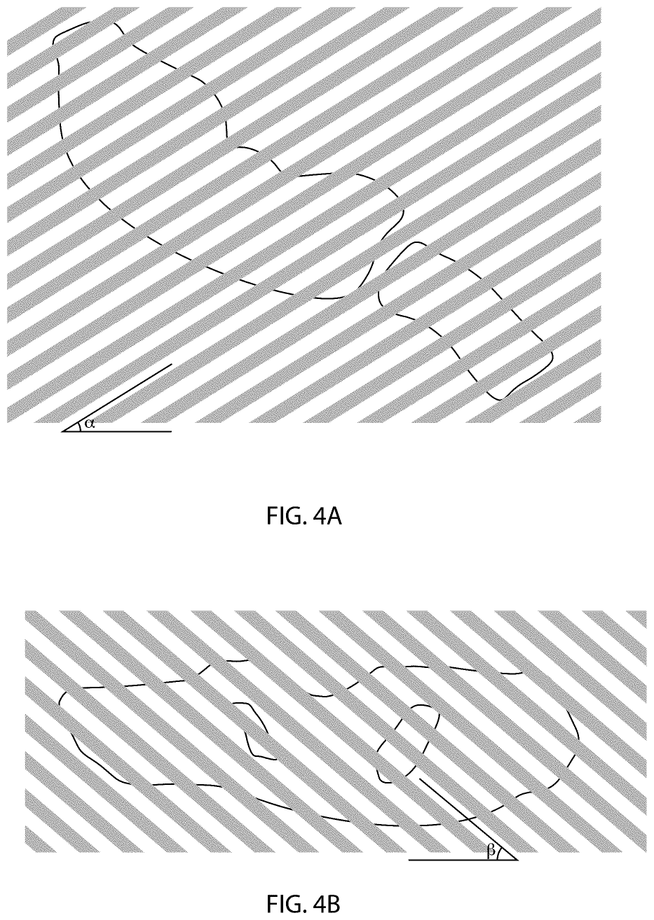

FIG. 4A shows a global swath pattern overlaid on the first work area 301 and the second work area 302 of FIG. 3A. The global swath pattern in FIG. 4A has an angle of α.

FIG. 4B shows a global swath pattern overlaid on the work area 308 of FIG. 3B. The global swath pattern in FIG. 4B has an angle of β. Note that the angle α and β are substantially different.

In both FIG. 4A and FIG. 4B these swath angles are measured from horizontal. Any arbitrary line can be used.

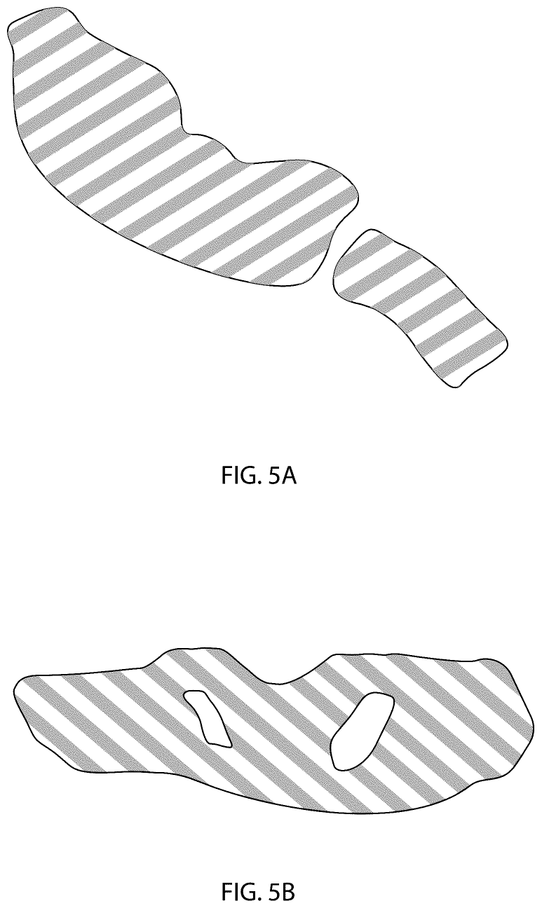

FIG. 5A shows a global swath pattern applied to the first work area 301 and the second work area 302. FIG. 5B shows a global swath pattern applied to the work area 308 without the first island 304 and the second island 306.

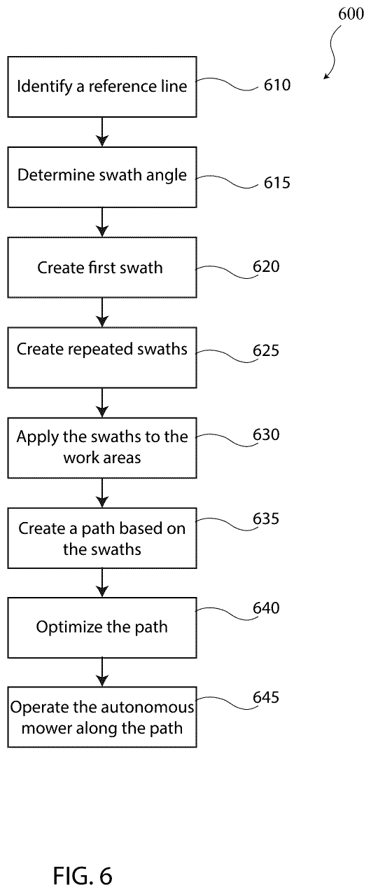

FIG. 6 is a flowchart of a process 600 for creating a global swath pattern. The blocks in the process 600 may occur in any order. Any number of blocks, for example, may be included at any point within the process 600. Any of the blocks, for example, may be removed. Any of the blocks may include, for example, any number of subblocks, steps, or processes.

At block 605 an arbitrary reference line can be selected. The reference line may be any line within the work area or near the work area. The reference line, for example, may be horizontal or vertical. The reference line may be a default selection or entered by a user.

At block 610 swath angle may be selected. For example, an angle of 45 degrees may be selected. The angle may be selected based on a longitudinal axis of one of one of the work areas. The angle may be perpendicular or 90 degrees from a longitudinal axis of one of the work areas. The angle may change over time for repeated work on the same work area.

At block 620 a first swath may be created. The first swath may include an angle relative from the reference angle and may extend well across the work areas. The first swath may also have a direction. The first swath may have a thickness that is substantially the width of the autonomous mower's mowing width.

At block 625, a plurality of repeated swaths may then be created each with the same width and the same angle, and with every other swath having alternating directions. The plurality of swaths may have a length that extends beyond the edges of each work area. This plurality of swaths may be considered a global swath pattern.

At block 630, the global swath pattern may be applied to the work areas. For example, the global swath pattern may be applied to the first area and the second area as shown in FIG. 5A by cutting the swath where the swaths cross the boundary of the work areas and removing the portions of the swaths that are not part of work areas.

As another example, the global swath pattern may be applied to the work area 308 with the first island 304 and the second island 306 removed by cutting the swath where the swaths cross the boundary of the work areas, cutting the swaths at the boundaries of the islands, and removing the portions of the swaths that are part of the islands.

At block 635 a path may be created. A path starting point may be selected. The path starting point, for example, may be selected arbitrarily. The path starting point, for example, may be selected by user input. The path starting point, for example, may be selected based on the current location of the autonomous mower. The path starting point, for example, may be selected based on a proximity to a path that is on an edge of the work area; often the edge has the smallest path length. The path starting point, for example, may be selected as the map origin.

Once a path starting point has been selected, a path may be created by connecting adjacent swaths starting with starting point. The path, for example, may proceed down the middle of each path in the direction of the swath. The end point of a first swath may be connected with the start point of the adjacent swath. This connection may include a turning path that allows the autonomous mower to turn around and move to the next swath. The path may include completing one portion of a work area on one side of an island and completing other portions on the other side of the island with a path that moves the mower to the other side of the island when the previous side has been completed. Various other connecting paths may be used.

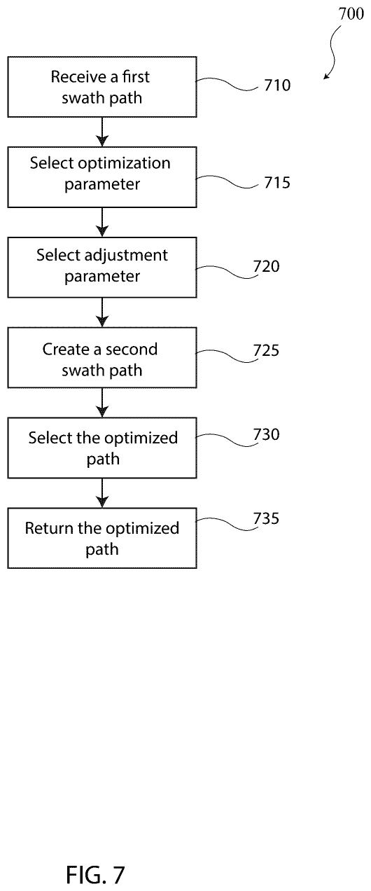

At block 640 the path may be optimized. This optimization may occur in any number of ways such as, for example, as shown in process 700 in FIG. 7.

At block 645, the autonomous mower may be operated to follow the path and create the swath pattern within the work areas.

FIG. 7 is a flowchart of a process 700 for optimizing a swath pattern. The blocks in the process 700 may occur in any order. Any number of blocks, for example, may be included at any point within the process 700. Any of the blocks, for example, may be removed. Any of the blocks may include, for example, any number of subblocks, steps, or processes.

At block 710 a first swath path may be received. The swath path, for example, may be received from process 600. At block 715, an optimization parameter may be selected. The optimization parameter, for example, may include total path length, number of swaths, etc.

At block 720 an adjustment parameter may be selected. The adjustment parameter, for example, may include the starting point, the swath angle, etc.

At block 725 a second swath path may be created with a different adjustment parameter than the first swath path. This second swath path may be created using process 600. For example, the second swath path may be created with a different reference angle having a difference of 1 to 5 degrees.

As another example, a second swath path may be created with a different starting point that the first swath path. This second swath path may be created using process 600. A second path length for the second path may be calculated.

A block 730 the optimized path may be selected. For example, the first path length and the second path length can be compared. The path with the shortest path length may be selected as the optimized path. Alternatively, the number of swaths in the first path and the number of swaths in the second path may be compared. The path with the fewest swaths may be selected.

As another example, the two paths may be compared based on other parameter such as the number of turns required by the autonomous mower when following the path, the time required to follow the path, the number of swaths required to cover the work areas.

At block 735, the optimized path may be returned. The optimized path may be returned.

The processes of block 700 may be repeated any number of times. For example, process 700 may be repeated with different optimization parameters and/or different adjustment parameters. As another example, the process 700 may be repeated a set number of times. As another example, the process 700 may be repeated until the different in the optimization parameter is below a threshold value.

The computational system 800, shown in FIG. 8 can be used to perform any of the examples disclosed in this document. For example, computational system 800 can be used to execute process 600 and process 700. As another example, computational system 800 can perform any calculation, identification and/or determination described here. Computational system 800 includes hardware elements that can be electrically coupled via a bus 305 (or may otherwise be in communication, as appropriate). The hardware elements can include one or more processors 310, including without limitation one or more general-purpose processors and/or one or more special-purpose processors (such as digital signal processing chips, graphics acceleration chips, and/or the like); one or more input devices 315, which can include without limitation a mouse, a keyboard and/or the like; and one or more output devices 320, which can include without limitation a display device, a printer and/or the like.

The computational system 800 may further include (and/or be in communication with) one or more storage devices 325, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 800 might also include a communications subsystem 330, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 330 may permit data to be exchanged with a network (such as the network described below, to name one example), and/or any other devices described in this document. The computational system 800, for example, may include a working memory 335, which can include a RAM or ROM device, as described above.

The computational system 800 also can include software elements, shown as being currently located within the working memory 335, including an operating system 340 and/or other code, such as one or more application programs 345, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 325 described above.

The storage medium, for example, might be incorporated within the computational system 800 or in communication with the computational system 800. The storage medium might be separate from a computational system 800 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 800 and/or might take the form of source and/or installable code, which, upon compilation and/or installation on the computational system 800 (e.g., using any of a variety of generally available compilers, installation programs, compression/decompression utilities, etc.) then takes the form of executable code.

Although term “autonomous mower” includes manned vehicles, remote control vehicles, manual vehicles, etc.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples disclosed in this document. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific examples, those skilled in the art, upon attaining an understanding of these examples, may readily produce alterations to, variations of, and equivalents to such examples. Accordingly, the present disclosure has been presented for purposes of example rather than limitation, and does not preclude inclusion of such modifications, variations and/or additions to the present subject matter as would be readily apparent to one of ordinary skill in the art. That which is claimed:

1. An autonomous work vehicle comprising:
a steering control system for autonomously controlling a driving direction of the autonomous work vehicle;
a speed control system for autonomously controlling a speed of the autonomous work vehicle;
a sensor array comprising one or more sensors;
one or more processors communicatively coupled with the sensor array, the steering control system, and the speed control system; and
one or more computer-readable media having stored thereon instructions that when executed cause the one or more processors to:
identify a reference line within a map of the two unconnected work areas;
determine a swath angle;
create a plurality of swaths based on the swath angle relative to the reference line, wherein alternating swaths represent opposite directions, and wherein the plurality of swaths overlap the two unconnected work areas within the map;
trim the plurality of swaths based on geometric shape of the two unconnected work areas; and
create a swath path from the plurality of swaths.

2. The autonomous work vehicle according to claim 1, wherein the two unconnected work areas are not contiguous.

3. The autonomous work vehicle according to claim 1, wherein the two unconnected work areas are adjacent.

4. The autonomous work vehicle according to claim 1, wherein the instructions further cause the one or more processors to operate the autonomous work vehicle along the swath path to create a swath pattern across the two unconnected work areas.

5. The autonomous work vehicle according to claim 1, wherein the instructions further cause the one or more processors to optimize the swath path by modifying the swath angle.

6. The autonomous work vehicle according to claim 1, wherein the instructions further cause the one or more processors to optimize the swath path by modifying a starting point of the swath path.

7. The autonomous work vehicle according to claim 1, wherein creating the path comprises connecting adjacent swaths along the swath path.

8. The autonomous work vehicle according to claim 1, wherein the swath path proceeds along the center of each swath within the boundaries of the two unconnected work areas.

9. The autonomous work vehicle according to claim 1, wherein when the autonomous work vehicle proceeds along the swath path, a pattern is created in vegetation in each of the two unconnected work areas such that a swath line in one of the two unconnected work areas is aligned with a swath line of the other of the two unconnected work areas.

10. The autonomous work vehicle according to claim 1, further comprising a mower reel or blade, and wherein the unconnected work areas comprise unconnected grass fairways.

11. A method for creating a global swath pattern in two unconnected fairways for an autonomous mower, the method comprising:
identifying a reference line within a map of the two unconnected fairways;
determining a swath angle;
creating a plurality of swaths based on the swath angle relative to the reference line, wherein alternating swaths represent opposite directions, and wherein the plurality of swaths overlap the two unconnected fairways within the map;
trimming the plurality of swaths based on geometric shape of the two unconnected fairways; and
creating a swath path from the plurality of swaths.

12. The method according to claim 11, wherein the two unconnected fairways are not contiguous.

13. The method according to claim 11, wherein the two unconnected fairways are adjacent.

14. The method according to claim 11, further comprising operating the autonomous mower along the swath path to create a swath pattern across the two unconnected fairways.

15. The method according to claim 11, further comprising optimizing the swath path by modifying the swath angle.

16. The method according to claim 11, further comprising optimizing the swath path by modifying a starting point of the swath path.

17. The method according to claim 11, wherein creating the swath path comprises connecting adjacent swaths along the swath path.

18. The method according to claim 11, wherein the swath path proceeds along the center of each swath within the boundaries of the two unconnected fairways.

19. The method according to claim 11, wherein when an autonomous mower proceeds along the swath path, a pattern is mowed into vegetation in each of the two unconnected fairways such that a swath line in one of the two unconnected fairways is aligned with a swath line of the other of the two unconnected fairways.

20. An autonomous mower comprising one or more computer-readable media having stored thereon instructions that when executed cause the one or more processors to execute the method according to claim 11.
